(19) United States
(12) Patent Application Publication
(10) Pub. No.: US 2012/0048577 A1
(43) Pub. Date: Mar. 1, 2012

(54) FIRE SUPPRESSION DEVICE

(76) Inventor: GREGORY KEATON BALL, Athens, WV (US)

(21) Appl. No.: 13/218,739

(22) Filed: Aug. 26, 2011

Related U.S. Application Data
(60) Provisional application No. 61/377,704, filed on Aug. 27, 2010.

(51) Int. Cl. A62C 3/00; A62C 2/00

(52) U.S. Cl. 169/46; 169/26; 169/65

(57) ABSTRACT

The present invention is a device to suppress or extinguish fires. In some embodiments, the fire extinguisher of the present invention comprises a fire extinguishing agent, a housing comprising a first material for retaining the fire extinguishing agent, and an attachment means for attaching the fire extinguisher to a surface. The fire extinguisher is actuated when the first material loses integrity upon exposure to a predetermined high temperature or exposure to open flames, resulting in a release of the fire extinguishing agent on the target area and thereby suppressing the fire or potential fire.

This application claims priority to U.S. Provisional Application Ser. No. 61/377,704 entitled “Kitchen Fire Suppression,” filed Aug. 27, 2010, the contents of which are incorporated herein in their entirety.

### BACKGROUND OF THE INVENTION

The field of the present invention is directed to fire suppression, and specifically, to automatic fire suppression that extinguishes active fires in kitchen cooking areas, and the like.

Many home and business fires are begun in the kitchen where stoves, ovens, and the like are used in cooking and heating foods. It is conventional for homes and businesses to have smoke and/or fire detectors which result in an alarm to alert people to the possibility of fire requiring people to either leave or fight the fire themselves. Automatic fire suppressors are also known. The most well known such system is a fire suppressant/extinguishing sprinkler system. Many commercial buildings have sprinkler systems while few single family homes have them.

U.S. Pat. No. 6,029,751 issued to Ford et al. on Feb. 29, 2000 discloses an automatic fire suppression apparatus and method, which includes a tank containing a suitable fire extinguishing agent and equipped with a temperature activated valve to discharge the extinguishing agent when a thermocouple or metallic alloy element responds to a high temperature condition and opens the valve. When the fire has been suppressed and a high temperature condition no longer exists, the valve automatically closes and stops the discharge of suppressant. The device may be placed in, or adjacent, a hood exhaust for a stove top.

U.S. Pat. No. 5,697,450 issued to Stehling et al. on Dec. 16, 1997 teaches fire extinguishing systems to suppress fires on cook stoves, fryers or other heating or heated devices with fire suppressant dispensed through nozzles is powered by batteries which provide current for both a detection circuit including a pair of heat sensors and control circuitry and current for a gas or electric house current shut-off A canister of fire suppressant is connected to the system as a source of the suppressant dispensed through nozzles.

U.S. Pat. No. 5,127,479 also issued to Stehling et al. shows a fire extinguishing system for a residential cookstove or range includes a fire extinguisher mounted above a hood in a cabinet positioned over the cookstove or range. The fire extinguisher is connected by flexible hoses and/or adjustable pipes to a pair of nozzles within the hood to dispense fire suppressant over the cookstove or range. The inventions of Stehling et al, incorporates tubing, piping or hosing to connect canister fire extinguishers or the like to the tubing, piping or hosing to deliver the fire suppressant to the cookstove or range.

Similarly, U.S. Pat. No. 4,773,485 issued to Silverman on Sep. 27, 1988 shows a fire extinguishing system for a cookstove and rangers that includes a canister fire extinguisher mounted above a hood positioned over the cookstove or range. The fire extinguisher is connected to a pair of nozzles within the hood to dispense fire suppressant over the cookstove or range.

U.S. Pat. No. 6,360,825 issued to Padgett et al. on Mar. 26, 2002 shows an automatic fire extinguisher system for use on cookstoves and ranges. The automatic fire extinguishing device is designed and configures to be removably secured to any sized commercial or residential range hood so as to offer protection by having a device that will automatically extinguish a fire. The device consists of a canister in the form of a hollow housing containing a fire suppressant, a mechanical movement device located therein to force the suppressant through the dissipation assembly out a release mechanism.

U.S. Pat. No. 7,182,143 issued to Hall et al. on Feb. 27, 2007 teaches an automatic appliance tire extinguisher system that includes a fire extinguisher container containing a pressurized fire retardant. A delivery tube is connected to the container in fluid communication with the pressurized fire retardant and to a fusible tip that melts once a temperature exceeds the melting temperature thereof. Upon melting the fusible tip, the pressurized fire retardant travels down the delivery tube out of the fusible tip.

U.S. Pat. No. 4,979,572 issued to Mikulec on Dec. 25, 1990 shows afire extinguisher installation in which the device is installable in a hood over the stove that uses a canister fire suppressant and tubing to communicate the fire suppressant to the stove top. U.S. Pat. No. 5,297,636 issued to North on Mar. 29, 1994 has a similar device that also delivers suppressant via tubing to underneath the stove top.

U.S. Pat. No. 5,868,205 issued to Cunningham et al. on Feb. 9, 1999 discloses a self-contained automatic fire extinguisher device which includes a container having container walls defining a container chamber for storage of a fire extinguishing agent therein, which is disposed in a vessel, both having at least one opening there through each, with a heat responsive closure/actuating element coupled to the container for substantially selectably sealing the at least one aperture to alternately prevent and permit fluid communication between the container and vessel. The fire extinguishing agent may then be released directly from the container when actuated.

U.S. Pat. No. 6,173,791 issued to Yen on Jan. 16, 2001 discloses a fire prevention system using water mist to extinguish a fire from underneath a hood over a fryer. The device consists of a tip connected to a tubing system extending from a remote water container with compressed air containers such that when the tip is opened the water is dispersed as a mist from the tip to put out a fire. The containers are located some distance from the tip.

U.S. Pat. No. 6,952,169 issued to Simtion on Oct. 4, 2005 teaches a wireless automatic detection and suppression system that has tubing with tips or nozzles in fluid communication with a pressurized cylinder containing fire extinguishing agent.

These inventions demonstrate the need for a convenient automated fire extinguishing system for putting out fires on stoves and the like. These devices have the inconvenience of requiring actuation through an automatic process similar to a sprinkler being actuated in response to heat. Most of these devices require some assembly upon being placed in the hood or above a cooking surface. Furthermore, most of these devices require recharging and periodic examination of the canister containing the fire suppressant/extinguishing agent.

### SUMMARY OF THE INVENTION

The present invention is a device to suppress or extinguish fires. In some embodiments, the fire extinguisher of the present invention comprises a fire extinguishing agent, a housing comprising a first material for retaining the fire extinguishing agent, and an attachment means for attaching the fire extinguisher to a surface. The fire extinguisher is actuated when the first material loses integrity upon exposure to a predetermined high temperature or exposure to open flames, resulting in a release of the fire extinguishing agent on the target area. The target area is a location at which a fire could originate, such as a location near any device that generates heat or is combustible and is therefore considered to be a fire hazard. The fire extinguisher is placed so that the fire extinguishing agent is released on the target area. In some embodiments, the first material loses integrity by melting upon exposure to an actuation event.

The first material of the fire extinguisher provides the feature that is actuated upon the occurrence of an actuation event. The first material loses structural integrity when exposed to the predetermined high temperature or to open flames. The loss of integrity allows the release of the fire extinguishing agent. The first material can be, for example, but not limited to, a thermoplastic material, an adhesive, a fibrous material, a metal containing material, a thermoset, and combinations thereof.

In some embodiments, the fire extinguisher further comprises a second material. In at least some embodiments, the second material is more heat resistant than the first material and does not lose integrity when exposed to the predetermined high temperature or to the open flames for a defined period of time.

In some embodiments, the fire extinguisher comprises a first outer housing and a second inner housing, wherein at least the second inner housing comprises the first material. In some embodiments, the first outer housing comprises an opening for release of the fire extinguishing agent. In some embodiments, the first outer housing comprises the first material and the second material, wherein the first material is placed to facilitate release of the fire extinguishing agent.

The fire extinguishing agent is any agent appropriate for suppressing or extinguishing a fire. In some embodiments, the fire extinguishing agent is selected from the group consisting of a powder, a foam, a gel and a liquid. In some embodiments, the fire extinguishing agent is retained under pressure in the fire extinguisher.

The attachment means for attaching the fire extinguisher to a surface can be any mechanical means known to one of ordinary skill in the art. For example, the attachment means can be screws, nails, bolts, adhesives, tape, magnets and/or hanging systems.

The surface to which the fire extinguisher is attached can be any desired surface. In at least some embodiments, the fire extinguisher is attached to or located near a fire hazard. In some embodiments, the surface is a stovetop or range hood, or the inner upper surface of an oven. In some embodiments wherein the surface is the stovetop or range hood, the fire extinguisher of the present invention further comprises a circuit for actuating an exhaust fan in the stovetop or range hood.

The present invention comprises a method of suppressing a fire. The method comprises placing a fire extinguisher near a fire hazard source wherein the fire extinguisher comprises a fire extinguishing agent and a housing comprising at least a first material for retaining the fire extinguishing agent, and wherein the first material loses integrity upon exposure to a predetermined high temperature or exposure to open flames. The loss of structural integrity by the first material results in the actuation of the fire extinguisher and the release of the fire extinguishing agent onto the target area, thereby suppressing the fire or potential fire by damping the flames and/or suppressing the overheated or smoldering material, thus reducing the risk that the fire will grow and spread. In some embodiments, the fire hazard is an electrical-, battery- or gas-powered appliance. In some embodiments, the appliance is a stovetop, a cooking range, or an oven.

### BRIEF DESCRIPTION OF THE DRAWINGS

The novel features of the described embodiments are specifically set forth in the appended claims; however, embodiments relating to the structure and process of making the present invention, may best be understood with reference to the following description and accompanying drawings.

FIG. 1A shows a sectional side view of a fire extinguisher in accordance with embodiments of the invention.

FIG. 1B shows a side sectional view of the fire extinguisher of FIG. 1A in accordance with embodiments of the invention.

FIG. 2 shows a perspective view of a fire extinguisher in accordance with embodiments of the invention.

FIG. 3 shows an environmental view of a fire extinguisher in accordance with embodiments of the invention.

FIG. 4 shows a fire extinguisher in accordance with embodiments of the invention.

FIGS. 5A-5C show a fire extinguisher in accordance with embodiments of the invention.

FIG. 6 shows an environment for using a fire extinguisher in accordance with embodiments of the invention.

Similar reference characters denote corresponding features consistently throughout the attached drawings.

### DETAILED DESCRIPTION

The present invention is a device to suppress or extinguish fires. In some embodiments, the fire extinguisher of the present invention comprises a fire extinguishing agent, a first material for retaining the fire extinguishing agent, and an attachment means for attaching the fire extinguisher to a surface. The fire extinguisher is actuated when the first material loses integrity upon exposure to a predetermined high temperature or exposure to open flames, resulting in a release of the fire extinguishing agent on a target area.

The fire extinguisher of the present invention is useful with respect to providing fire protection near fire hazards. A fire hazard is any item that that generates heat or is combustible. Examples of fire hazards include, but are not limited to, electrical-, battery- and gas-powered devices, and flammable materials. A target area is a location at which a fire is likely to originate or spread, and the fire extinguisher of the present invention is placed so that the fire extinguishing agent is released on the target area. A target area is easily discerned by one of ordinary skill in the art. Examples of the target area include areas that are located near a fire hazard and are exposed to heat such as electronic circuitry, motors, flame or heat sources, breaker boxes, and the like. For example, a target area of a stovetop or range is a burner on which pots or pans are heated. In another example, a target area is a breaker box. In yet another example, a target area is a location where combustibles or flammable materials are stored, such as a garage or a chemistry lab.

The first material of the fire extinguisher provides the response to an actuation event. The first material loses structural integrity when exposed to an actuation event such as a predetermined high temperature or open flames. As used herein, the phrase “structural integrity” or term “integrity” refers to the ability of a material to keep its shape or not weaken when exposed to high temperatures or open flames. In some embodiments, a material that maintains its integrity is able to securely and fully retain the fire extinguishing agent. Thus, for example, when the integrity of the first material is intact, the fire extinguishing agent is retained and there are no openings through which the agent can escape. The loss of integrity allows the release of the fire extinguishing agent. The first material can be, for example, but is not limited to, a thermoplastic material, an adhesive, a fibrous material, a metal containing material, or a thermoset.

For some embodiments of the present invention, actuation events include (1) at least one surface of the first material of the fire extinguisher reaching a predetermined high temperature and (2) the occurrence of open flames that cause actuation by either touching at least one surface of the fire extinguisher or by increasing the temperature of at least one surface of the first material of the fire extinguisher until it reaches the predetermined high temperature. The actuation events serve to automatically activate the fire extinguisher's release of the fire extinguishing agent. For example, the actuation event causes the first material to lose structural integrity by fully or partially melting, softening, liquefying, decomposing, weakening, and/or burning, thus resulting in the release of the fire extinguishing agent.

Once the fire extinguisher of the present invention has been placed for use, its activation is automatic upon the occurrence of an actuation event. When the actuation event is the predetermined high temperature, the predetermined high temperature is selected based at least partly on the application for which the fire extinguisher is to be used. The predetermined high temperature is an approximate temperature at which the first material loses structural integrity and the fire extinguisher is actuated. In other embodiments, the activation of the fire extinguisher is independent of the actuation event. For example, a manual or electronic opening mechanism may be employed to deploy the fire extinguishing agent. In this way, a user can actuate the fire extinguisher to prevent a potentially dangerous situation. The smoke point of refined canola oil is about 475° F. and is well below the flash point (about 600° F.) of refined canola oil. A user may, for example, manually actuate the fire extinguisher upon seeing smoke even if the temperature has not risen to the temperature necessary to automatically activate the fire extinguisher. In cases where the first material loses integrity upon contact with a flame, for example, the user may manually actuate the fire extinguisher upon formation of flames that have not yet reached the vicinity of the first material.

The actuation event further includes a temporal aspect. Due to the nature of the use of a fire extinguisher, it is generally better to have the fire extinguisher respond quickly to an actuation event. Thus, a reaction time is measured based on the amount of time required for actuation to occur following exposure to the actuation event, and first materials are selected based at least in part on the reaction time.

Physical properties such as melting point, brittleness, water resistance, density, thickness, or a combination of properties of the first material may be selected based on the environment in which the fire extinguisher is to be used. For example, the melting point of the first material may be high enough to withstand the heat given off during normal use such as heat given off by steam or oven coils, but low enough to melt upon exposure to elevated temperatures and/or a flame. In some embodiments, the melting point range of the first material is from about 100° F. to about 1500° F. In other embodiments, the melting point range of the first material is from about 150° F. to about 550° F. In other embodiments, the melting point range of the first material is from about 200° F. to about 400° F. In addition to withstanding elevated temperatures associated with normal use, the first material may also be selected to withstand other factors such as moisture, vibrations, applied force and the like.

In one example, the fire extinguisher is to be placed in the hood of a stovetop or range in a private residence above a target area comprising a burner and the predetermined temperature is a temperature below the flash point of most cooking oils, which is about 600° F. In this example, the predetermined high temperature is about 550° F. and the first material is a thermoplastic with a melting point at or below 550° F. In another example, the predetermined high temperature is desired to be no more than about 550° F. before actuation occurs, but can be as low as, for example, 250° F., allowing for a wider selection of thermoplastics that can be used as the first material. In another example, the predetermined temperature is about 451° F., or the temperature at which paper ignites, and the first material is paper. In yet another example, an open flame is the actuator as it touches an external area of the fire extinguisher, resulting in the loss of integrity of the first material and subsequent release of the fire extinguishing agent. In some cases, the open flame does not touch an external area of the fire extinguisher, but rather serves as an actuator by causing an increase in temperature until the predetermined high temperature is achieved.

The first material is any material that maintains its structural integrity under the normal conditions required by the environment in which the fire extinguisher is to be used but loses its structural integrity upon the occurrence of an actuation event. Thus, the first material must be heat resistant enough to withstand normal conditions of the environment in which the fire extinguisher is to be used. For example, if the fire extinguisher is to be placed in a stovetop or range hood above the burners of the stove or cook top, the first material must be able to withstand the temperatures produced by normal cooking activity on the burners without losing integrity.

Examples of first materials include, but are not limited to, be a thermoplastic material that melts upon the occurrence of an actuation event, an adhesive that melts upon the occurrence of an actuation event, a paper that burns upon the occurrence of an actuation event, a thermoplastic that softens or melts upon the occurrence of an actuation event, or a metal containing material that melts upon the occurrence of an actuation event. The first material includes, without limitation, a thermoplastic material, an adhesive, a fibrous material, a metal containing material, or a thermoset, and combinations thereof.

The thermoplastic material includes thermoplastic polymers. Examples of such polymers include polymers or copolymers of olefin monomers including ethylene, propylene, vinyl chloride, styrene, butylene, isobutylene, and vinyl acetate. Other polyolefins may be used. In addition, the thermoplastic polymer may be a copolymer of acrylic monomers such as acrylic acid, and ionomers thereof, including sodium acrylate and acrylic esters e.g. methyl and ethyl acrylate, methyl or ethyl methacrylate, and ethylene/acrylic acid (EAA) copolymers. Copolymers of acrylic monomers with olefines and vinyl monomers are also included, e.g. ethylene-acrylic acid copolymer, ethylene-methyl acrylate copolymer, acrylonitrile-butadiene-styrene polymers. Elastomeric copolymers or terpolymers of olefines may be used, such as ethylene-propylene elastomer, ethylene-propylene-diene (e.g. butadiene) elastomer e.g. EPDM polymers. In addition the thermoplastic polymer may be a polycondensation product such as polyamides, polyurethanes, polyesters and polycarbonates. Examples of polyurethanes are condensation products of polyisocyanates and a hydroxyl-containing material, including polymers of hexamethylene disocyanate and 1,4-butanediol. Examples of polyamides are polymers of lactams and amino carboxylic acids and polymers of dicarboxylic acids and diamines, including nylon 6, nylon 11, nylon 12, nylon 6,6, nylon 6,10, nylon 12,12 and the like. Examples of polyesters are polymers of dicarboxylic acids and dihydroxy compounds including polyethylene terephthalate and polybutylene terephthalate. The polymer composition may contain one polymer or a mixture of two or more polymers as the final application requires. The thermoplastic material, in some embodiments of the invention, is combined with a thermoset to adjust the hardness or melting temperature range of the thermoplastic material.

The adhesive includes hot-melt adhesives, pressure sensitive adhesives, polymeric adhesives, biodegradable adhesives, epoxies and the like. The adhesive may include thermoplastic polymers, elastomers, block copolymers, ethylene copolymers, polyolefins, biodegradable polymers, rubbers, polyurethanes, silicone containing polymers, polyurethanes, polyamides, polycarbonates, fluoropolymers, and the like. The adhesive may further include tackifiers, waxes, cellulosic materials, fillers, plasticizers, coloring agents, biocides, fire retardants, and the like.

The fibrous material includes papers, fabrics, textile materials, fibers, sheets, yarn, fiber bundles, woven materials, non-woven materials, and the like. The fibrous material further includes any natural, cellulosic, or wholly synthetic material, and/or combinations thereof. The fibrous material includes natural plant based materials such as hemp, wood, cotton, bamboo, cellulose, jute, flax, starches, albardine, esparto, wheat, rice, corn, sugar cane, papyrus, jute, reed, sabia, raphia, sidal, kenaf, abaca, sunn, rayon (also known as viscose), lyocell, cotton, hemp, flax, ramie and combinations thereof. The fibrous material may also include natural non-plant based materials such as silk, down, feathers, and the like. The synthetic material includes fibers made of any material, such as, but not limited to, those selected from the group consisting of glass, polyesters (e.g., polyethylene terephthalate), polyolefins, polypropylenes, polyethylenes, polyethers, polyamides, polyesteramides, polyvinylalcohols, polyhydroxyalkanoates, polysaccharides, and combinations thereof. Further, the synthetic fibers can be a single component (i.e., single synthetic material or mixture makes up entire fiber), bi-component (i.e., the fiber is divided into regions, the regions including two or more different synthetic materials or mixtures thereof and may include co-extruded fibers and core and sheath fibers) and combinations thereof. It is also possible to use bicomponent fibers. These bicomponent fibers can be used as a component fiber of the structure, and/or they may be present to act as a binder for other fibers present in the fibrous structure. Any or all of the synthetic fibers may be treated before, during, or after manufacture to change any desired properties of the fibers. In some embodiments, the fibrous material includes a fire retardant. For example, a fire retardant may be mixed in with a resin used to make a fabric or may be applied topically to a fabric to impart heat resistance to the fabric.

The metal containing material includes low-melting-point metals or alloys (e.g., a solder) essentially containing any one or ones of those metals. Examples of the low-melting-point metals include aluminum, magnesium, zinc, tin, lead, bismuth, terbium, tellurium, cadmium, thallium, astatine, polonium, selenium, lithium, indium, sodium, potassium, rubidium, cesium, francium, and gallium, or alloys essentially containing those metals. The metal elements or alloys which can be kneaded, melted, and molded with an injection molding machine such as for instance an in-line screw type injection molding machine.

In some embodiments, the fire extinguisher further comprises a second material. In at least some embodiments, the second material maintains its structural integrity under the normal conditions required by the environment in which the fire extinguisher is to be used and in at least some embodiments maintains its structural integrity upon the occurrence of an actuation event. The second material can be, for example, but is not limited to, heat resistant materials such as high melting point metals, metal alloys, ceramics, glass materials, silicones, polycarbonates, thermosetting materials, polyamides, phenol formaldehydes, fluoropolymers, heat resistant biodegradable polymers, and the like. Examples of the high melting point metals and metal alloys include copper, nickel, steel, and cast iron. In some embodiments, the second material may be treated to impart heat resistance. For example, the second material may be coated with polytetrafluorethylene. As another example, the second materials may be mixed with a fire retardant or treated with a fire retardant. Examples of the flame retardant include organic phosphoric acid ester flame retardants, halogenated phosphoric acid ester flame retardants, inorganic phosphorus-based flame retardants, halogenated bisphenol-based flame retardants, other halogenated compounds, antimony-based flame retardants, nitrogen-based flame retardants, boron-based flame retardants, metal salt-based flame retardants, inorganic flame retardants, and silicon-based flame retardants. These may be used alone or in combination.

The fire extinguishing agent is any agent appropriate for suppressing or extinguishing a fire. In some embodiments, the fire extinguishing agent is selected from the group consisting of a powder, a foam, a gel, and a liquid. In some embodiments, the fire extinguishing agent is retained under pressure in the fire extinguisher. For example, the fire extinguishing agent may be pressurized with a propelling agent such as nitrogen, helium, argon, carbon dioxide or other inert gases.

Examples of the fire extinguishing agent includes sodium bicarbonate, potassium bicarbonate, potassium bicarbonate—urea complex, ammonium borate, potassium borate, sodium borate (borax), sodium sulfate, sodium phosphate, sodium polyphosphate, sodium chloride, potassium chloride, ammonium bromide, monoammonium phosphate, ammonium polyphosphate, potassium citrate, potassium acetate, lactic acid, potassium hydroxide, perfluorocarbons, hydrofluorocarbons, graphite powder, bromochlorodifluoromethane, bromotrifluoromethane, water, CO2, or nitrogen, and combinations thereof. The fire extinguishing agent may further include foam agents, gelling agents, desiccants, lubricants, surfactants, adsorbents, calcium chloride, diatomaceous earth, calcium stearate silicones, silica, alumina, and the like.

In some embodiments, the fire extinguishing agent comprises a BC or ABC dry chemical powder. For example, the fire extinguishing agent may include an alkali metal carbonate, an alkali metal bicarbonate, an alkaline earth metal carbonate, an alkaline earth metal bicarbonate or mixtures thereof. In other embodiments, the fire extinguishing agent comprises a wet chemical. The wet chemical may, for example, be used in kitchen fires that involve cooking oils and fats. For example, the wet chemical may include potassium bicarbonate, potassium acetate, and/or potassium acetate. In some embodiments, the fire extinguishing agent comprises liquid carbon dioxide under pressure.

The attachment means for attaching the fire extinguisher to a surface can be any mechanical means known to one of ordinary skill in the art. For example, the attachment means can be screws, nails, bolts, adhesives, tapes, magnets, and/or hanging systems. The fire extinguisher is placed in a position so that the fire extinguishing agent is released onto a target area. In some embodiments, the fire extinguisher is positioned above the target area so that gravity is utilized in pulling the fire extinguishing agent onto the target area. In some embodiments, the hanging system is adjustable so that the fire extinguisher's position relative to the target area is adjustable, enabling adaptation of the fire extinguisher to current conditions.

In some embodiments, the fire extinguishing agent is retained under pressure in the fire extinguisher, allowing the agent to be released with some force. The fire extinguisher may include a pressurized vessel for holding the fire extinguishing agent and nozzle from which the fire extinguishing agent is expelled. In some cases, the nozzle includes an actuation device comprising the first material. When exposed to an actuating event such as a flame, the actuation device loses integrity and triggers the released of the pressurized fire extinguishing agent. The actuation device may be a plastic or solder trigger that melts upon exposure to high temperatures or flames.

The surface to which the fire extinguisher is attached can be any desired surface. In at least some embodiments, the fire extinguisher is attached to or located near an electrical, gas, coal burning, charcoal burning, battery-powered and/or wood burning appliance. In some embodiments, the surface is a stovetop or range hood, or the inner surface of an oven. In some embodiments wherein the surface is the stovetop or range hood, the fire extinguisher of the present invention further comprises a circuit for actuating an exhaust fan in the stovetop or range hood. The foregoing are simply exemplary locations at which the fire extinguisher of the present invention can be located. One of ordinary skill in the art understands that the fire extinguisher of the present invention can be placed in any location for which a potential fire hazard and a target area for release of the fire extinguishing agent can be identified. For example, the fire extinguisher may be placed near or attached to machinery, mixers, microwaves, kitchen equipment, fireplaces, furnaces, electrical equipment, breaker boxes and the like.

The fire extinguisher of the present invention offers a number of advantages. An aspect of the present invention is that the cost is substantially less than that of most fire suppression devices on the market today. Since it requires no expensive electronic devices or intricate system to actuate the fire suppression device, more customers are likely to use the present invention than conventional devices.

The device of the present invention can be made in many different shapes and sizes, and can therefore be tailored to any application. In some embodiments, the invention is fitted or retrofitted to existing exhaust hoods above residential ranges or stove tops. In some embodiments, the invention is fitted or retrofitted to existing exhaust hoods above commercial ranges or stove tops. In some embodiments, the invention is fitted or retrofitted to existing ovens. In some embodiments, the invention is fitted or retrofitted to or near other devices that present fire hazards, such as any electrical-, battery- or gas-powered appliance.

The fire extinguisher of the present invention can be sized and shaped to fit any situation. For example, the present invention can be designed to appear like a hood screen, a flat surface, or be a geometric shape such as a tube, cone, or rectangle. An embodiment of the present invention fits within the fan area of a kitchen stove hood, and may be conformed to fit dimensions of a variety of fan areas. Another embodiment is designed to fit into the top portion of an oven, above the area where food is placed to be cooked For example, the fire extinguisher may be attached to the top surface of the oven by a hanging system. Another embodiment is designed to fit a side wall of the oven, with the fire extinguishing agent retained under pressure in the fire extinguisher so that upon actuation, the fire extinguishing agent is dispersed throughout the oven.

As is understood by one of ordinary skill in the art, fires of different types require different types of fire suppressing or extinguishing materials. Therefore, the fire extinguishing agents used in the present invention are varied based on the intended use of the device. For example, the type of fire expected in a residential kitchen is different from the type of fire expected in a warehouse. Therefore, the fire extinguishing agent of the device can be matched to the intended use of the device. In the United States, types of fires are rated by a code (A, B, C, D, F, etc.). For example, potassium acetate may be used for a grease-fueled kitchen fire, whereas, CO2 may be used for an electrical fire. Thus, it is easily understood by one ordinary skill in the art how to select a fire extinguishing agent appropriate to the intended use of the fire extinguisher of the present invention.

The first and second materials can be varied, just as the fire extinguishing agent can be varied, based on the intended use of the device of the present invention. The location at which the device is to be placed gives an indication of the types of fires that can be expected at that location. As used herein, the “types of fires” refers to the material that is the origin of the fire and the material burning to produce the fire. For example, in a residential kitchen fire, the fire may be produced from food burning (such as an oil reaching its flash point), a pot melting and catching fire, or an equipment malfunction that results in an electrical fire. In a fire caused by gas-powered device, the fire may be fueled by the input of gas from a gas line that normally feeds the device. An expected temperature range of the fire produced in each situation can be determined, and the temperature range can be used to determine materials appropriate for use as the first and second materials of the fire extinguisher of the present invention.

The present invention provides an inexpensive fire suppressant device for use in any location in which a fire suppressant device is desirous, such as residential kitchens, commercial kitchens, commercial warehouses and any other room or location within any building in which a fire suppressant device is desired. Examples of buildings in which the present invention can be used include, but are not limited to, a business, a school, a church, a restaurant, a cafeteria, a club house, and a private residence.

In some embodiments, the fire extinguisher of the present invention does not require sophisticated equipment, electronics, water hook up under pressure, or the like in order to function. The fire extinguisher of the present invention is suitable for use in multiples (such as one fire extinguisher of the present invention placed above each burner of a stove top, or one fire extinguisher of the present invention placed above each row of burners on a stove top).

In some embodiments, the fire extinguisher of the present invention is also suitable for use in combination with other fire suppression systems. In one example, a fire extinguisher of the present invention further comprises a circuit for actuating an exhaust fan in a stovetop hood. In another example, the fire extinguisher of the present invention is placed in an area containing at least one other fire suppression device or system. The structure of the fire extinguisher of the present invention makes it unlikely to interfere with other fire suppression devices and systems, making it ideal as either a stand-alone device or for use to complement other fire suppression devices and systems.

The present invention is suitable for placement near any device or appliance that can present a fire hazard, including but not limited to kitchen appliances (including ovens, ranges, stoves, dishwashers, refrigerators, toasters, toaster ovens, mixers, blenders, and deep fryers), compressors, heat pumps, furnaces, air conditioners, clothes washers, clothes driers, water heaters, breaker boxes, flammable liquids, hoods in chemical labs, warehouse fire hazards, airplane hangers, etc. One of skill in the art recognizes that the present invention is useful in any location where there is a fire hazard, and can be created in different forms to fit each environment.

The fire extinguisher of the present invention comprises a first material containing a fire extinguishing agent. In some embodiments, the fire extinguisher of the present invention comprises a housing made of a first material, wherein the first material loses its structural integrity upon reaching a predetermined high temperature and thereby releases the fire extinguishing agent. In some embodiments, the fire extinguisher comprises a housing made of a first material and a second material, wherein the first material loses its integrity upon reaching a predetermined high temperature and the second material remains intact upon reaching the predetermined high temperature.

In some embodiments, the fire extinguisher comprises a first outer housing and a second inner housing, wherein at least the second inner housing comprises the first material. In some embodiments, the fire extinguisher comprises a first outer housing and a second inner housing, wherein at least the second inner housing comprises the first material and wherein the first outer housing comprises an opening for release of the fire extinguishing agent.

In some embodiments, the fire extinguisher comprises a first outer housing made of a first material and a second material, and a second inner housing made of the first material, wherein the first material is placed in the first outer housing to facilitate release of the fire extinguishing agent. Other combinations of housings and materials are within the scope of the invention, and one of ordinary skill in the art would understand how to create combinations of housings and for building the automatically actuated fire extinguisher of the present invention.

In some embodiments, the fire extinguisher of the present invention is easily replaced after use. Prior art devices are typically recharged or reset which can require the assistance of a professional. In at least some embodiments, the present invention is a single use device, and after actuation all that is required is removal of the spent device and installation of a replacement device.

In one example, the fire extinguisher comprises a housing and a fire extinguishing agent, and the replacement device comprises the housing and the fire extinguishing agent. In another example, the fire extinguisher comprises a first outer housing, a second inner housing, and a fire extinguishing agent, and the replacement device comprises the first outer housing, the second inner housing and the fire extinguishing agent.

In some embodiments, one portion or only particular components of the fire extinguisher are replaced without replacing the entire device. In one example, the fire extinguisher comprises a first outer housing, a second inner housing, and a fire extinguishing agent, and the replacement device comprises the second inner housing and the fire extinguishing agent. For example, the second inner housing and the fire extinguishing agent can be replaced through an access area or opening in the first outer housing. Alternatively, the first outer housing can be replaced by removing the fire extinguisher from the attachment means, removing the second inner housing and the fire extinguishing agent from the first outer housing, placing the second inner housing and the fire extinguishing agent in the replacement first outer housing, and installing the replacement first outer housing on the attachment means.

In some embodiments, the fire extinguishing agent is replaceable. Such replacement can be necessary if the fire extinguishing agent has an expiration date and needs to be replaced to maintain the functionality of the fire extinguisher. In one example, the fire extinguishing agent is replaced through an opening or access means in the housing(s).

In at least some embodiments, the attachment means comprises an element attached to the surface on which the fire extinguisher is located that is reusable upon replacement of the fire extinguisher. For example, a bracket or brackets forming a hanging system for the fire extinguisher are installed during initial installation of the fire extinguisher, and then re-used with any replacement fire extinguishers that must be obtained and installed. Other means of attachment include, but are not limited to, bolts, screws, nails, tape, glues or adhesives, and magnets.

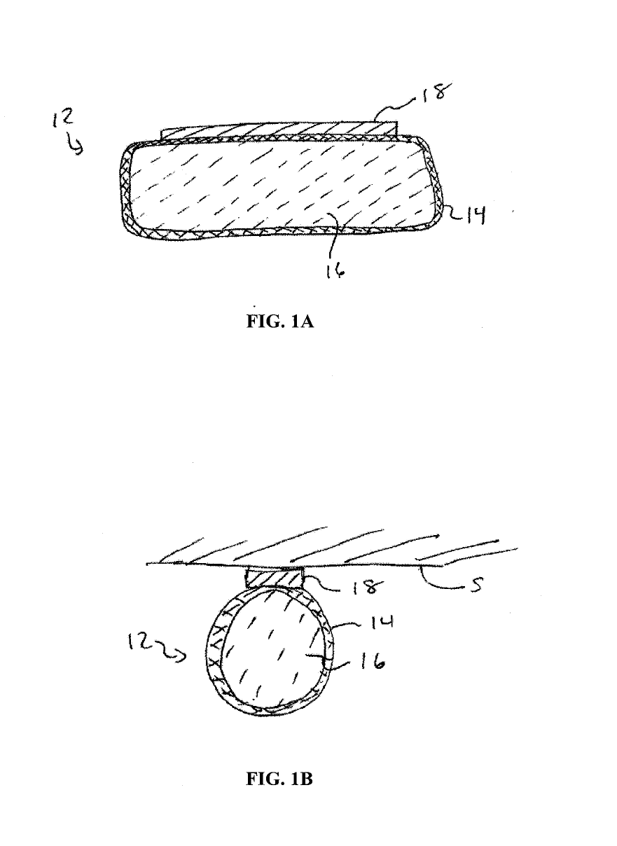

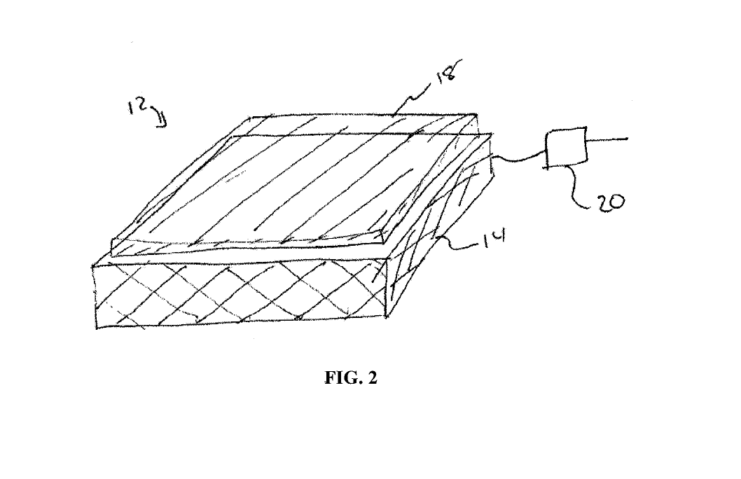

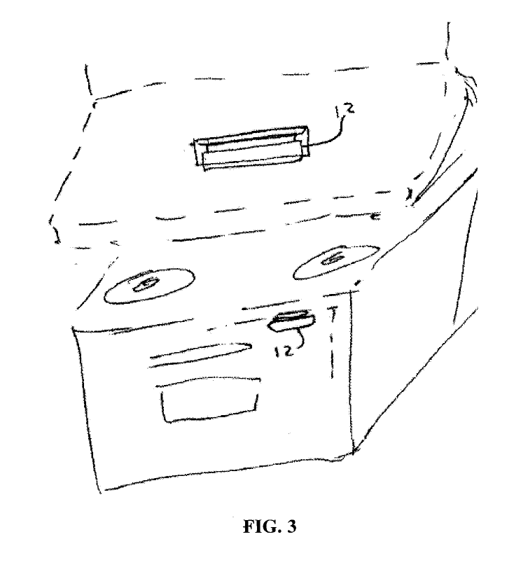

FIG. 1a shows a sectional side view of an embodiment of an automatic kitchen fire extinguisher 12 according to the present invention. FIG. 1b is a side sectional view of an embodiment of the present invention of FIG. 1a. FIG. 2 shows a perspective view of an alternative embodiment of the present invention. FIG. 3 shows an environmental view of alternative embodiments of the present invention as used, wherein the environment is a stove with burners, an oven and a hood.

The automatic fire extinguisher 12 has a fire extinguishing agent 16 encompassed by a housing 14, and an attachment means 18. The housing 14 is made of a first material that melts at a temperature above the normal operating temperature of the oven or stove or in response to being exposed to flames directly and releases the fire extinguishing agent 16 onto the target area.

In some embodiments, the housing 14 of the fire extinguisher 12 comprises a first material and a second material, wherein the first material loses integrity when exposed to a predetermined high temperature, thus actuating the fire extinguisher and releasing the fire extinguishing agent 16 onto the target area. The second material, in some embodiments, comprises a majority of the surface area of the first housing 14. In one example, the housing 14 comprises a structure wherein the majority of the structure includes a high melt metal (the second material) and a narrow strip of the structure includes a nonwoven material (the first material). In such structures, the narrow strip loses integrity when exposed to elevated temperatures such that the fire extinguishing agent 16 is released while the remaining portions of the structure stay intact. In other words, in such structures the second material has a higher melting temperature than the first material.

The fire extinguisher 12 may have a tubular shape, as shown in FIGS. 1A and 1B. Alternatively, FIG. 1A may be a side view of a fire extinguisher with a rectangular shape. In other examples, the fire extinguisher 12 may have a rectangular shape (FIG. 2) or a shape complimentary to a fan in a hood. A vast range of shapes are possible so long as the first material is exposed directly to the target area, such as the heat of the oven or stove.

As shown in FIG. 2, a circuit 20 for actuating an exhaust fan in a stovetop hood may also be present. The attachment means 18 may be either a magnet, tape, or a strip of glue, which can be used at the desired temperature without failure of the attachment means.

In some embodiments, a fire extinguisher of the present invention is mounted in a range hood above the stove top or range in a residential kitchen. The fire extinguisher is made of a material able to withstand the heat given off by the burners during normal use. Such materials include, but are not limited to, thermoplastic, thermoset, metal, glass, paper and wood.

A method of suppressing a kitchen fire, according to the present invention, involves placing an automatic fire extinguisher 12 under the hood of a stove S or in the oven, as shown in FIG. 3, the automatic fire extinguisher 12 having a fire extinguishing agent 16 encompassed by a housing 14 and an attachment means 18. In another example, the method of suppressing a kitchen fire involves an automatic fire extinguisher having a fire extinguishing agent encompassed by a first housing, a second housing, and an attachment means.

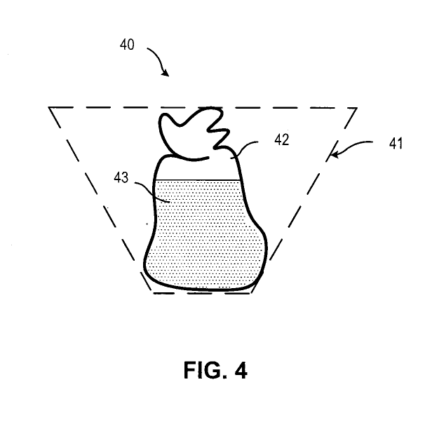

Referring now to FIG. 4, another fire extinguisher 40 in accordance with some embodiments of the invention is illustrated. The fire extinguisher 40 includes a first housing 41 having a cavity formed therein, where a second housing 42 is positioned within the cavity. In some embodiments, the second housing 42 is at least partially in contact with the first housing 41. Although the first housing 41 is conical in shape in the illustrated embodiment, it will be understood that the first housing 41 may be formed in any shape. In some embodiments, the first housing 41 comprises the first material and/or second material. For example, the first housing 41 may be a steel conical container. In the illustrated embodiment, the second housing 42 is a plastic bag. However, the second housing 42 may further include any container, such as a rigid canister.

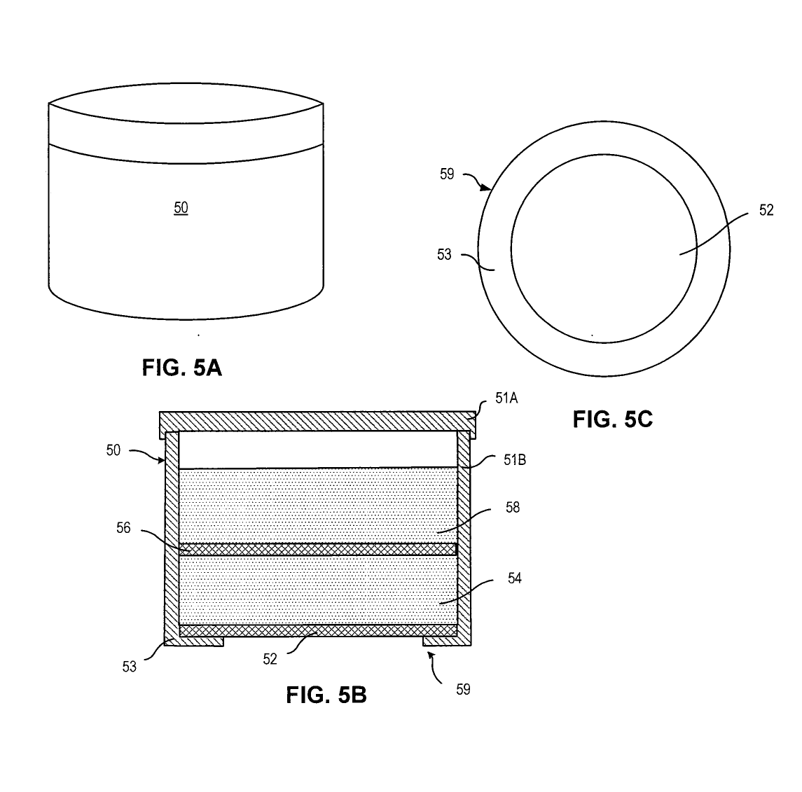

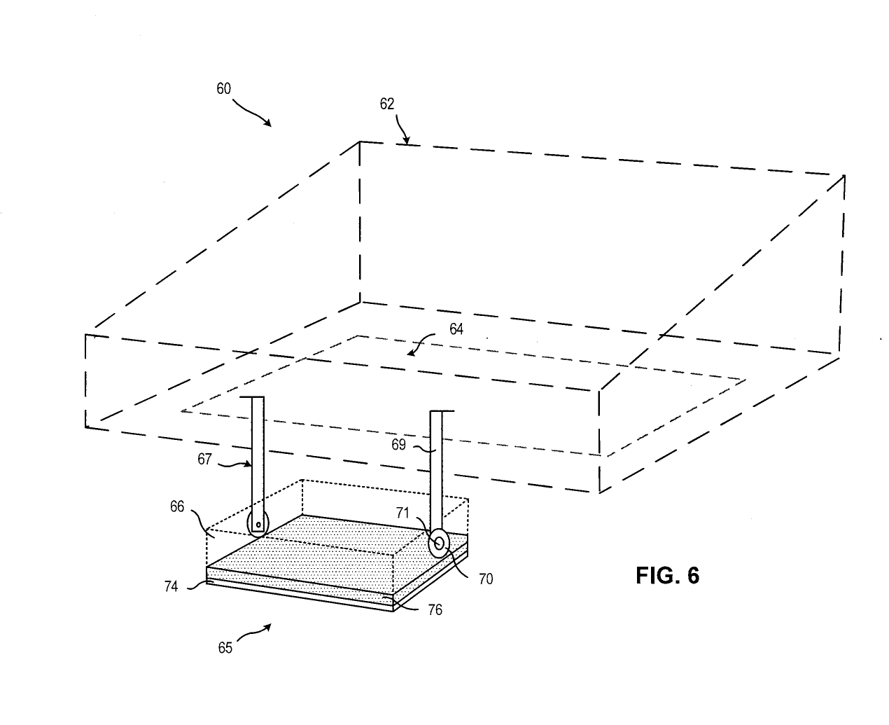

In some embodiments, the second housing 42 includes the first material. Enclosed in the second housing 42 is one or more fire extinguishing agents 43 as shown in FIG. 4. In other embodiments, the fire extinguishing agent 43 is not enclosed in a second housing, but is in contact with the first housing 41 (see, e.g., FIGS. 5A-6). In still other embodiments, the bottom portion of the first housing 41 has an opening formed therein. In this way, at least a portion of the second housing 42 melts or otherwise loses integrity when exposed to flames or elevated temperatures and releases the fire extinguishing agent 43 to suppress a fire positioned beneath the fire extinguisher 40. In other embodiments, the bottom portion of the first housing 41 comprises the first material. For example, the side and top portions of the first housing 41 may be composed of the heat resistant plastic and the bottom portion composed of a low melting metal.

FIGS. 5A-5C illustrate a fire extinguisher 50 according to another embodiment of the invention. Although the fire extinguisher 50 is illustrated as a cylinder, it will be understood that the fire extinguisher 50 may be formed in any shape. As shown in FIGS. 5A-5B, the fire extinguisher 50 includes a removable top portion 51A, a body portion 51B, and a bottom portion 59. The body portion 51B has a cavity, a top opening and a bottom opening formed therein. The top portion 51A extends over the top opening formed in the body 51B. In some embodiments, the bottom plate 52 comprises the first material and the body portion 51B comprises the second material.

Referring now to FIG. 5C, a bottom view of the bottom portion 59 is illustrated. The bottom portion 59 includes a bottom plate 52 and a rim 53 that extends along the circumference of the bottom opening as shown in FIG. 5B. As shown in the illustrated embodiment, the circumference of the bottom plate 52 is larger than the circumference of the bottom opening. The bottom plate 52 is positioned above the rim 53 such that the bottom plate 52 extends over the bottom opening (FIG. 5B). The bottom plate 52 may be installed in the fire extinguisher 50 by removing the top portion 51A and placing the bottom plate 52 in contact with the rim 53. In some embodiments, the partition 56 and/or fire extinguishing agents 54 and 58 are first removed before the bottom plate 52 is installed in the fire extinguisher 50.

Although the fire extinguisher 50 is illustrated as having separable portions, it will be understood that the fire extinguisher 50 may include any number of separable or inseparable portions. For example, in some embodiments, the bottom plate 52 and portions of the body 51B are inseparable such that the first material and the second material are formed as a unitary structure. For example, the bottom portion 59 may be blow molded to form a single structure in which a portion of the structure is formed from the first material and a portion of the second structure is formed from the second material. In other embodiments, the bottom portion 59 includes mechanical fasteners. For example, the mechanical fastener (e.g., screws, hinges, etc.) may be used to attach the bottom plate 52 to the body portion.

Enclosed in the fire extinguisher 50 are a first fire extinguishing agent 54 and a second fire extinguishing agent 58. The fire extinguishing agents 54 and 58 may be the same or different in composition. As shown in FIG. 5B, the agents 54 and 58 are separated by a removable partition 56. The partition 56, in some embodiments, comprises the first material. The first material of the partition 56, in some embodiments, is the same as the first material of the bottom plate 52. For example, both the bottom plate 52 and the partition 56 may be composed of ethylene vinyl acetate. In other embodiments, the first material of the bottom plate 52 is different from the first material of the partition 56. In some embodiments, the fire extinguisher includes any number of partitions and/or fire extinguishing agents. For example, the fire extinguisher may include only the bottom plate 52 or may include two or more partitions.

In some embodiments, at least a portion of the bottom plate 52 loses integrity when exposed to high temperatures or flames. For example, the bottom plate 52 may weaken or disintegrate resulting in the release of the first fire extinguishing agent 54 and the suppression of a fire positioned below the fire extinguisher 50. If the fire is suppressed by the first fire extinguishing agent 54, for example, the partition 56 and the second fire extinguishing agent 58 remain intact and the extinguisher 50 may be used again. In some cases, the partition 56 and second fire extinguisher 58 may be used as a backup in cases where the fire danger remains after the release of the first fire extinguishing agent 54.

Referring now to FIG. 6, an environment 60 for using another embodiment of the fire extinguisher is illustrated. A hood 62 for a cooking appliance (e.g., a stovetop oven) is illustrated in FIG. 6. The hood 62 includes a ventilation area 64 of a ventilation system. Typically, the ventilation system includes one or more fans or air flow devices (not shown) that draw vapors up from the cooking appliance area through a duct system such that the vapors are released into an outer area.

Attached to the ventilation area 64 is a fire extinguisher 65. The fire extinguisher 65 may be placed anywhere within the vicinity of the hood. For example, the fire extinguisher 65 may be placed over one or more burners of a stovetop, or over the entire stovetop area depending on the size of the fire extinguisher 65. The fire extinguisher 65 includes a body 66, a hanging system 67, and a replaceable bottom cover 74. In some embodiments, the body 66 comprises the second material and/or first material. For example, the body 66 may be composed of ceramic or steel.

The fire extinguisher 65 is attached to the ventilation area 61 by a hanging system 67. The hanging system 67 includes one or more bars 69 that are attached to a portion of the fire extinguisher via a washer 70 and a bolt 71. The hanging system may further include a locking mechanism such as a screw or clamp that locks the fire extinguisher 65 at a certain angle. In this way, a user may adjust the position of the fire extinguisher 65. Although a hanging system is illustrated, it will be understood that the fire extinguisher 65 may be attached to a portion of the hood 62 by any mechanical fastening means. In some embodiments, the fire extinguisher 65 may be repositioned via the hanging system 67 to adjust the distance between the bottom cover 74 and a target area. For example, the fire extinguisher 65 may be moved up or down the length of the bars 69 to increase or decrease the distance between the bottom cover 74 and a burner positioned beneath the bottom cover 74. Notches (not shown), for example, may be formed in the bars 69 to facilitate the upward and downward movement of the fire extinguisher 65.

Formed in the body 66 are a cavity and a bottom opening. A layer 76 comprising one or more fire extinguishing agents is positioned within the cavity. Positioned beneath the layer 76 is the bottom cover 74 that extending over the bottom opening formed in the body 66. The bottom cover 74 includes the first material and/or the second material. For example, the bottom cover 74 may be formed by mixing a low melting polymer with a high melting polymer and extruding the mixture. The bottom cover 74 may also include a first portion comprising the first material and a second portion comprising the second material. In another embodiment, the bottom cover 74 may be composed of entirely the first material. In some embodiments, the bottom cover 74 is attached to the body 66 via a mechanical fastener. For example, the bottom cover 74 may be attached to the body 66 using hinges.

In some embodiments, a kit comprising the fire extinguisher 40, 50, or 65 is provided. In some embodiments, the kit comprising the fire extinguisher 40 includes one or more of the second housing 42 and a quantity of the one or more fire extinguishing agents 43. In other embodiments, the kit comprising the fire extinguisher 50 includes one or more of the bottom plate 52, one or more of the top portion 51A, and one or more of the of the body portion 51B. The kit comprising the fire extinguisher 50 also includes, in some embodiments, extra quantities of the fire extinguishing agents 54 and 58. In still other embodiments, the kit comprising the fire extinguisher 65 includes one or more of the bottom cover 74, one or more spares of the washer 70 and bolt 71, and/or extra quantities of the fire extinguishing agents. Further, the kit may also include mechanical fasteners such as magnets or screws for attaching the fire extinguishers 40, 50, and or 60 to a surface; textual and/or pictorial instructions for installation and use of the fire extinguishers 40, 50 and/or 65; and printed suggestions for preventing fires.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein. It is to be understood that the present invention is not limited to the embodiments described above, but encompasses any and all embodiments within the scope of the following claims.

What is claimed is:

1. A fire extinguisher comprising:
a fire extinguishing agent;
a housing comprising a first material for retaining the fire extinguishing agent, wherein the first material loses integrity upon exposure to a predetermined temperature or exposure to open flames, thereby actuating the fire extinguisher and releasing the fire extinguishing agent on a target area; and
an attachment means for attaching the fire extinguisher to a surface.

2. The fire extinguisher of claim 1, wherein the first material melts upon exposure to the predetermined temperature or exposure to open flames.

3. The fire extinguisher of claim 1, wherein the housing further comprises a second material, wherein the second material is more heat resistant than the first material.

4. The fire extinguisher of claim 1, comprising a first outer housing and a second inner housing, and wherein at least the second inner housing comprises the first material.

5. The fire extinguisher of claim 4, wherein the first outer housing comprises an opening for release of the fire extinguishing agent.

6. The fire extinguisher of claim 4, wherein the first outer housing comprises the first material and a second material.

7. The fire extinguisher of claim 6, wherein the first material is placed to facilitate release of the fire extinguishing agent.

8. The fire extinguisher of claim 1, wherein the fire extinguishing agent is retained under pressure.

9. The fire extinguisher of claim 1, wherein the fire extinguishing agent is selected from the group consisting of a powder, a foam, a gel, and a liquid.

10. The fire extinguisher of claim 1, wherein the first material is selected from the group consisting of a thermoplastic material, a fibrous material, a metal containing material, and an adhesive.

11. The fire extinguisher of claim 1, wherein the attachment means is selected from the group consisting of screws, nails, bolts, adhesives, tape, magnets and hanging systems.

12. The fire extinguisher of claim 1, wherein the surface is selected from the group consisting of a stovetop hood and an inner surface of an oven.

13. The fire extinguisher of claim 12, wherein the surface selected is the stovetop hood and further comprising a circuit for actuating an exhaust fan in a stovetop hood.

14. A method of suppressing a fire, comprising:
placing a fire extinguisher near a fire hazard, wherein the fire extinguisher comprises a fire extinguishing agent and a housing comprising at least a first material for retaining the fire extinguishing agent, and wherein the first material loses integrity upon exposure to a predetermined high temperature or exposure to open flames, thereby releasing the fire extinguishing agent on a target area and suppressing the fire or potential fire.

15. The method of claim 14, wherein the fire hazard is a stovetop, a cooking range, or an oven.
